(19) United States
(12) Patent Application Publication
(10) Pub. No.: US 2007/0065778 A1
(43) Pub. Date: Mar. 22, 2007

(54) Endosteal dental implant screwable into a human jaw bone for receiving and securing prosthetic teeth

(76) Inventor: Rainer Lippe, Kassel (DE)

Correspondence Address: PYLE & PIONTEK, ROOM 2036, 221 N LASALLE, CHICAGO, IL, 60601, US

(21) Appl. No.: 11/230,144

(22) Filed: Sep. 19, 2005

(51) Int. Cl. A61C 8/00

(52) U.S. Cl. 433/174

(57) ABSTRACT

The subject matter of the invention is an endosteal dental implant screwable into a human jaw bone for receiving and securing prosthetic teeth, with a base body (10) comprising a cortical region (13) adjoined with a threaded region (14) comprising an external thread (11), the outer diameter of the base body (10) in the cortical region (13) being greater or equal to the outer diameter of the external thread (11). A dental implant that is solidly anchored in the jaw bone immediately after implantation is provided by providing a sinusoidal thread (12) on the base body (10) in the cortical region (13).

### BACKGROUND OF THE INVENTION

1. Field of the Invention

The present invention relates to a dental implant as set forth in the preamble of claim 1.

2. Description of the Prior Art

A dental implant composed of three portions is known from DE 103 56 920 A1. The uppermost portion is thereby configured to be a cylindrical cortical region that is adjoined with a central region and with a distal region. In said central and distal regions there is provided an external thread that is configured, at least in the distal region, to be a self-tapping thread, whereas in the central region said external thread may also be configured to be a compression thread.

A cortical thread extending in the cortical region is provided to rise up from the surface of the base body, said thread having a depth of 0.01 mm to 0.3 mm, preferably of 0.05 mm. Said cortical thread, which comprises at least four convolutions, is preferably configured to be a compression thread but it may also be configured to be a self-tapping thread and extends over approximately a third of the overall length of the base body. Due to its small size, such a cortical thread, which is formed so as to extend and has a thread depth of preferably 0.05 mm contributes but minimally to the overall stability of the dental implant in the jaw bone, in particular in the axial direction, so that the main load has to be carried by the external thread located in the spongious jaw bone. Since one aims nowadays at making an impression immediately after having implanted the dental implant in order to prepare the prosthetic teeth, there is the risk that the dental implant will be undesirably pushed further into the jaw bone as the carrying capacity of the spongious jaw bone in the region of the external thread is not very good yet.

### BRIEF SUMMARY OF THE INVENTION

In view thereof, it is the object of the present invention to provide a dental implant of the type mentioned herein above that is solidly anchored in the jaw immediately after implantation.

As a technical resolution to this problem, a dental implant having the features of claim 1 or the features of claim 7 is proposed. Advantageous developed implementations of this dental implant will become apparent from the respective ones of the dependent claims.

A dental implant configured in accordance with this technical reaching presents the advantage that the sinusoidal thread with its symmetrical and sinusoidal flanks cuts its own hole into the cortical region of the jaw bone as the dental implant is being screwed in, thus reliably holding the dental implant in the axial direction since the cortical region of the jaw bone is so strong that it prevents, even immediately after implantation, the dental implant from sliding axially out of place. It has been found to be advantageous to have the sinusoidal thread protruding between 0.4 mm and 0.7 mm, preferably 0.5 mm, from the base body in order for the sinusoidal thread to be capable of cutting deep enough into the jaw bone. By having the sinusoidal thread markedly protruding from the base body, the implant hole is prevented from becoming larger.

First tests have shown that the desired effect is already obtained if the sinusoidal thread comprises merely two convolutions. It has thereby been found advantageous to configure the uppermost thread convolution, at least for its major part, without pitch, this missing pitch being anticipated to retain the dental implant in this position even in the long term so as to prevent it from being screwed further into the jaw through the forces generated by chewing as a result of the lever effects of the pitch.

In another preferred embodiment, the sinusoidal thread is spaced approximately 0.5 to 2 mm, preferably 1 mm, from the upper border of the base body. This permits to achieve that the sinusoidal thread screws itself completely into the cortical jaw bone instead of lying loose thereon.

Further advantages of the dental implant of the invention will become apparent from the attached drawing and the embodiments described herein after. Likewise, the above mentioned features and those described herein after may be used alone or in any combination with each other within the scope of the present invention. The embodiments mentioned are merely exemplary in nature and are not intended to limit the scope of the invention.

### BRIEF DESCRIPTION OF THE SEVERAL VIEWS OF THE DRAWINGS

FIG. 1a shows a first embodiment of a dental implant of the invention illustrated in partial section view;

FIG. 1b is a cross section through the sinusoidal thread of the dental implant according to FIG. 1, shown enlarged;

FIG. 2 shows a second embodiment of a dental implant of the invention illustrated in partial section view;

FIG. 3 shows a third embodiment of a dental implant of the invention illustrated in partial section view;

FIG. 4 shows a fourth embodiment of a dental implant of the invention illustrated in partial section view;

FIG. 5 shows a fifth embodiment of a dental implant of the invention illustrated in partial section view;

FIG. 6 shows a sixth embodiment of a dental implant of the invention illustrated in partial section view.

### DETAILED DESCRIPTION OF THE INVENTION

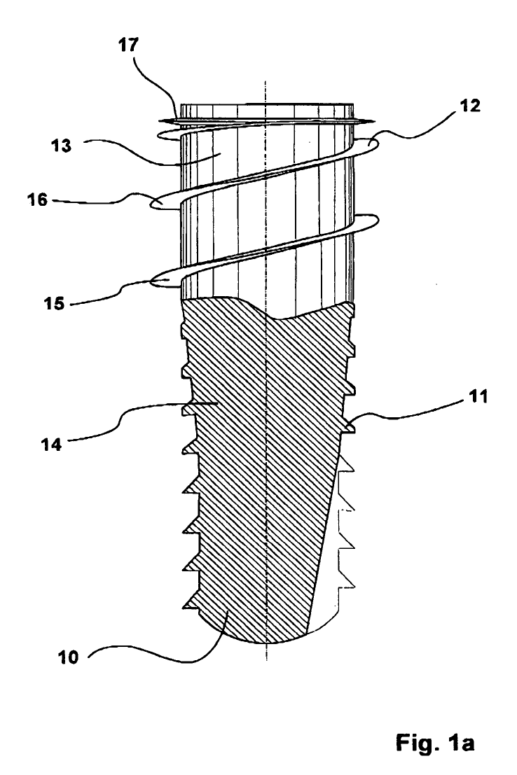

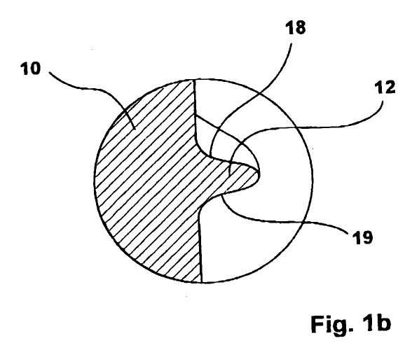

The FIGS. 1a and 1b illustrate a first embodiment of a dental implant of the invention comprising a base body 10, an external thread 11 and a sinusoidal thread 12, said external thread 11 and said sinusoidal thread 12 being each formed on the outside of the base body 10.

The base body 10 is divided into a cortical region 13 and a threaded region 14, with the cortical region 13 being configured to be substantially cylindrical and being located in the top region of the base body 10 so that this cortical region 13 comes to fit in the cortical substance of the jaw bone once implantation of the dental implant is completed. The cortical region 13 thereby takes about one third of the length of the base body 10 whilst the threaded region 14 extends over approximately two thirds of the base body 10.

In the threaded region 14, the external thread 11 is formed on the base body 10 with the external thread 11 being configured to be a self-tapping thread in its lower region and a compression thread in its upper region adjoining the cortical region 13. The discrete convolutions of the external thread 10 are thereby configured so as to cause the outer contour of the external thread 11 to adopt a cylindrical shape, the outer diameter of the external thread 11 corresponding to the outer diameter of the cortical region. Accordingly, together with the external thread 11, the cortical region 13 forms a cylindrical outer shape.

In the cortical region 13, the sinusoidal thread 12 having a flank depth of about 0.5 mm is formed on and rises up from this cylindrical shape. This sinusoidal thread 12 comprises three complete thread convolutions 15, 16, 17, with the uppermost thread convolution 17 having no pitch when viewed over the entire circumference. Moreover, the uppermost thread convolution 17 is implemented so as to extend as far as the second thread convolution 16, thus closing the sinusoidal thread 12. The uppermost thread convolution 17 is thereby disposed at a distance of about 1 mm from the top edge of the base body 10.

As can be seen more specifically in FIG. 1b, the sinusoidal thread 12 configured to be a self-tapping thread is configured to be symmetrical, with the top flank 18 and the bottom flank 19 being configured to be substantially identical while exhibiting mirror symmetry. Hereby, the outer contour of the bottom and top flank substantially corresponds to a segment of a sinus curve, with the outer contour of the sinusoidal thread 12 being configured to be so sharp that the sinusoidal thread 12 cuts its own way into the cortical substance of the jaw bone as the dental implant is being screwed into the jaw bone.

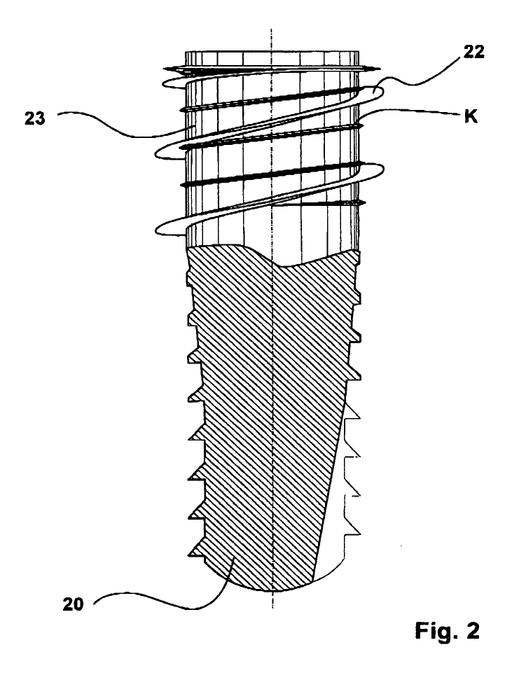

In the second embodiment illustrated in FIG. 2, a cortical thread K extending over four convolutions is formed in the cortical region 23 of the base body 20 in addition to the sinusoidal thread 22. Like the sinusoidal thread 22, this cortical thread K has been formed outside in the cortical region 23 of the base body 22. Its flank depth is about 0.05 mm and is devised to be a compression thread. This cortical thread K also ends about 1 mm below the top border of the base body 20.

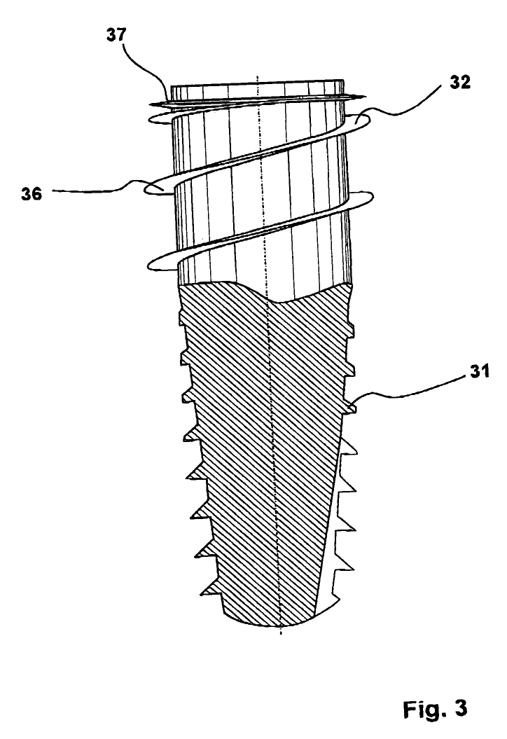

The third embodiment illustrated in FIG. 3 is substantially identical with the first embodiment illustrated in the FIGS. 1a and 1b but for the number of convolutions of the sinusoidal thread 22. In this second embodiment illustrated in FIG. 3, the sinusoidal thread 22 only has one convolution 26 the pitch of which is greater than the pitch of the convolutions of the external thread 21 and one convolution 25 that has no pitch. The thread convolution 25 (with no pitch) is thereby devised so as to end at such a distance from the thread convolution 26 that it will not get into touching contact therewith.

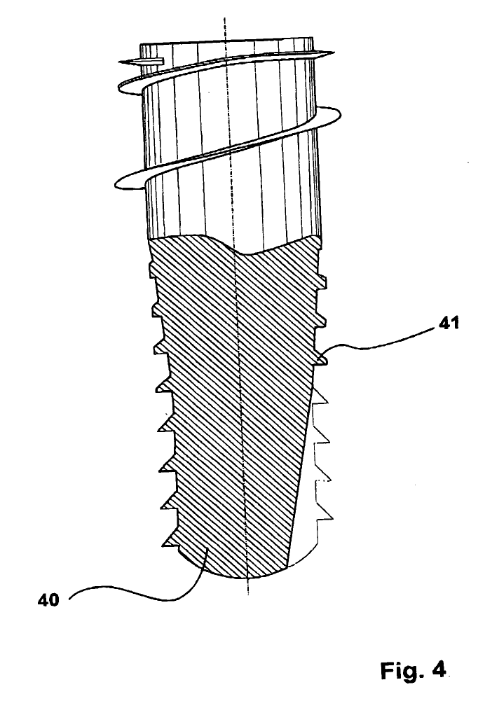

The fourth embodiment illustrated in FIG. 4 differs from the first embodiment illustrated in the FIGS. 1a and 1b in that the external thread 41 formed outside on the base body 40 comprises a conically tapering outer contour and tapers toward the distal end of the base body 40.

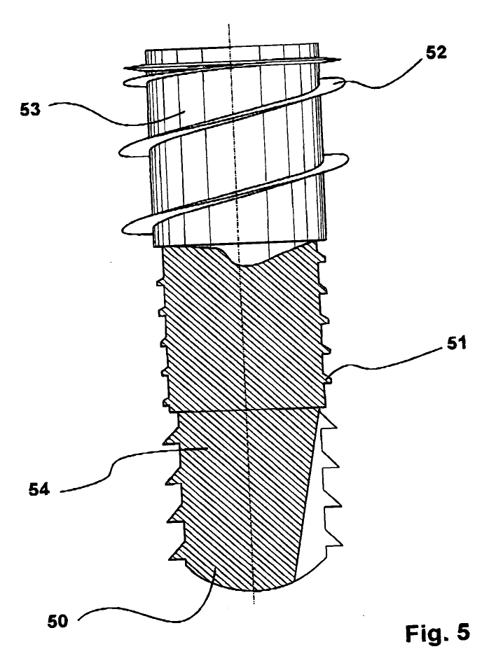

The fifth embodiment of the dental implant of the invention illustrated in FIG. 5 comprises a stepped threaded region 54 with the diameter of the second step being smaller than the diameter of the first step of said threaded region 54.

In this embodiment, the external thread 51 at the distal end of the base body 50 is configured to be a self-tapping thread and comprises a cylindrical outer contour. At the first step provided in the central region of the base body 50, the external thread 51 is configured to be a compression thread having a cylindrical outer contour and a diameter that is smaller than the lower portion of the external thread 61 and than the diameter of the cortical region 53.

The sinusoidal thread 52 and the cortical region 53 are configured as already described with reference to the first embodiment in accordance with the FIGS. 1a and 1b.

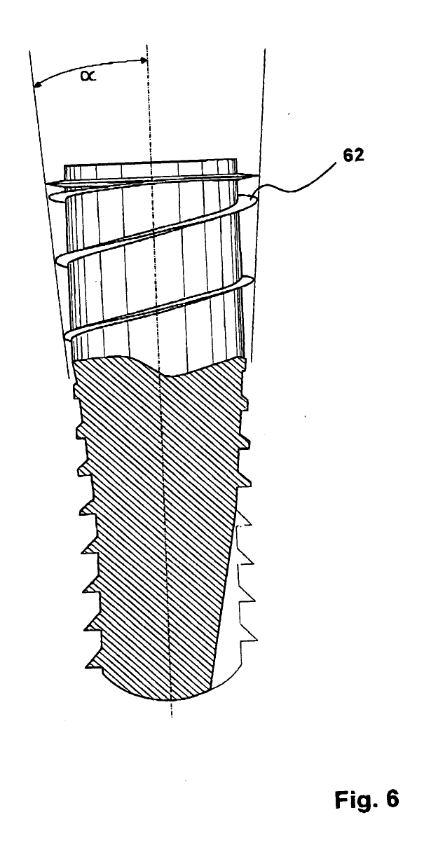

In the sixth embodiment illustrated in FIG. 6, the sinusoidal thread 62 has an outer contour that tapers conically downwards. The cone angle a is about 5°. For the rest, this sixth embodiment corresponds to the first embodiment described in the FIGS. 1a and 1b.

List of numerals:

| | | | | | | |
|---|---|---|---|---|---|---|
| 10 | 20 | | 40 | 50 | | base body |
| 11 | | 31 | 41 | 51 | | external thread |
| 12 | 22 | 32 | | 52 | 62 | sinusoidal thread |
| 13 | 23 | | | 53 | | cortical region |
| 14 | | | | 54 | | threaded region |
| 15 | | | | | | thread convolution |
| 16 | | 36 | | | | thread convolution |
| 17 | | 37 | | | | thread convolution |
| 18 | | | | | | bottom flank |
| 19 | | | | | | top flank |
| | K | | | | | cortical thread |
| | α | | | | | cone angle |

I claim:

1. An endosteal dental implant screwable into a human jaw bone for receiving and securing prosthetic teeth, with a base body (10, 20, 40, 50) comprising a cortical region (13, 23, 53) adjoined with a threaded region (14, 54) comprising an external thread (11, 31, 41, 51), the outer diameter of the base body (10, 20, 40, 50) in the cortical region (13, 23, 53) being greater or equal to the outer diameter of the external thread (11, 31, 41, 51),
characterized in that a sinusoidal thread (12, 22, 32, 52, 62) configured to be a self-tapping thread is provided on the base body (10, 20, 40, 50) in the cortical region (13, 23, 53), at least one portion of an uppermost thread convolution (17) of the sinusoidal thread (12, 22, 32, 52, 62) having no pitch and a free end of the uppermost thread convolution (17) extending as far as the thread convolution (16) lying underneath.

2. The dental implant as set forth in claim 1,
characterized in that the sinusoidal thread (12, 22, 32, 52, 62) has a maximum of three, preferably two, complete thread convolutions (15, 16, 17).

3. The dental implant as set forth in claim 1,
characterized in that the sinusoidal thread (12, 22, 25 32, 52, 62) has a cylindrical or conically tapering outer contour.

4. The dental implant as set forth in claim 1,
characterized in that the sinusoidal thread (12, 22, 32, 52, 62) has a flank depth of 0.4 mm to 0.7 mm, preferably of 0.5 mm.

5. The dental implant as set forth in claim 1,
characterized in that the sinusoidal thread (12, 22, 32, 52, 62) starts at a distance of about 0.5 to 2 mm, preferably of 1 mm, from the upper border of the base body (10, 20, 40, 50).

6. The dental implant as set forth in claim 1,
characterized in that the base body (10, 20, 40, 50) is configured to be cylindrical in the cortical region (13, 23, 53).

7. An endosteal dental implant screwable into a human jaw bone for receiving and securing prosthetic teeth, with a base body (10, 20, 40, 50) comprising a cortical region (13, 23, 53) adjoined with a threaded region (14, 54) comprising an external thread (11, 31, 41, 51), the outer diameter of the base body (10, 20, 40, 50) in the cortical region (13, 23, 53) being greater or equal to the outer diameter of the external thread (11, 31, 41, 51),
characterized in that a sinusoidal thread (12, 22, 32, 52, 62) is provided on the base body (10, 20, 40, 50) in the cortical region (13, 23, 53).

8. The dental implant as set forth in claim 7,
characterized in that the sinusoidal thread (12, 22, 32, 52, 62) is configured to be a self-tapping thread.

9. The dental implant as set forth in claim 7,
characterized in that the sinusoidal thread (12, 22, 32, 52, 62) has a maximum of three, preferably two, complete thread convolutions (15, 16, 17).

10. The dental implant as set forth in claim 9;
characterized in that at least one portion of an uppermost thread convolution (17) of the sinusoidal thread (12, 22, 32, 52, 62) has no pitch.

11. The dental implant as set forth in claim 10,
characterized in that a free end of the uppermost thread convolution (17) extends as far as the thread convolution (16) lying underneath.

12. The dental implant as set forth in claim 7,
characterized in that the sinusoidal thread (12, 22, 32, 52, 62) has a cylindrical or conically tapering outer contour.

13. The dental implant as set forth in claim 7,
characterized in that the sinusoidal thread (12, 22, 32, 52, 62) has a flank depth of 0.4 mm to 0.7 mm, preferably of 0.5 mm.

14. The dental implant as set forth in claim 7,
characterized in that the sinusoidal thread (12, 22, 32, 52, 62) starts at a distance of about 0.5 to 2 mm, preferably of 1 mm, from the upper border of the base body (10, 20, 40, 50).

15. The dental implant as set forth in claim 7,
characterized in that the base body (10, 20, 40, 50) is configured to be cylindrical in the cortical region (13, 23, 53).
